(19) United States
(12) Patent Application Publication
(10) Pub. No.: US 2014/0358942 A1
(43) Pub. Date: Dec. 4, 2014

(54) INFERRING GENDER FOR MEMBERS OF A SOCIAL NETWORK SERVICE

(71) Applicant: Linkedln Corporation, Mountain View, CA (US)

(72) Inventor: Ganesh Ramesh, Cupertino, CA (US)

(73) Assignee: Linkedln Corporation, Mountain View, CA (US)

(21) Appl. No.: 14/025,132

(22) Filed: Sep. 12, 2013

Related U.S. Application Data
(60) Provisional application No. 61/829,001, filed on May 30, 2013.

(51) Int. Cl. G06F 17/30

(52) U.S. Cl. CPC G06F 17/30861
USPC 707/748; 707/736

(57) ABSTRACT

Systems and methods for determining a member of a social network service is of a certain gender, and performing various actions associated with the determined gender, are described. For example, the systems and methods may access information from a social network service that is associated with a member of the social network service, and determine a gender for the member of the social network service that is based on characteristics of the accessed information. The systems and method may then perform an action for the member that is associated with the determined gender.

### CROSS REFERENCE TO RELATED APPLICATIONS

This application claims priority to U.S. Provisional Patent Application No. 61/829,001 filed on May 30, 2013, entitled INFERRING GENDER FOR MEMBERS OF A SOCIAL NETWORK SERVICE, which is hereby incorporated by reference in its entirety.

### TECHNICAL FIELD

The present disclosure generally relates to information retrieval within a social network service. More specifically, the present disclosure relates to methods, systems and computer program products for inferring gender for members of a social network service.

### BACKGROUND

Online social network services provide users with a mechanism for defining, and memorializing in a digital format, their relationships with other people. This digital representation of real-world relationships is frequently referred to as a social graph. Many social network services utilize a social graph to facilitate electronic communications and the sharing of information between its users or members. For instance, the relationship between two members of a social network service, as defined in the social graph of the social network service, may determine the access and sharing privileges that exist between the two members. As such, the social graph in use by a social network service may determine the manner in which two members of the social network service can interact with one another via the various communication and sharing mechanisms supported by the social network service.

Some social network services aim to enable friends and family to communicate and share with one another, while others are specifically directed to business users with a goal of facilitating the establishment of professional networks and the sharing of business information. For purposes of the present disclosure, the terms “social network” and “social network service” are used in a broad sense and are meant to encompass services aimed at connecting friends and family (often referred to simply as “social networks”), as well as services that are specifically directed to enabling business people to connect and share business information (also commonly referred to as “social networks” but sometimes referred to as “business networks” or “professional networks”).

With many social network services, members are prompted to provide a variety of personal information, which may be displayed in a member's personal web page. Such information is commonly referred to as “personal profile information”, or simply “profile information”, and when shown collectively, it is commonly referred to as a member's profile. For example, with some of the many social network services in use today, the personal information that is commonly requested and displayed as part of a member's profile includes a member's contact information, home town, address, the name of the member's spouse and/or family members, a photograph of the member, interests, and so forth.

With certain social network services, such as some business network services, a member's personal information may include information commonly included in a professional resume or curriculum vitae, such as information about a person's education, employment history, job skills, professional organizations, and so forth. With some social network services, a member's profile may be viewable to the public by default, or alternatively, the member may specify that only some portion of the profile is to be public by default. As such, many social network services serve as a sort of directory of people to be searched and browsed, as well as a repository of information associated with members of the social network service.

### DESCRIPTION OF THE DRAWINGS

Some embodiments of the technology are illustrated by way of example and not limitation in the figures of the accompanying drawings.

FIG. 1 is a block diagram illustrating various functional components of a suitable computing environment, consistent with some embodiments, for inferring the gender of members of a social network service.

FIG. 2 is a block diagram illustrating example modules of a gender inference engine, consistent with some embodiments.

FIG. 3 is a flow diagram illustrating an example method for performing an action for a member of a social network service that is based on an inferred gender for the member, consistent with some embodiments.

FIG. 4 is a flow diagram illustrating an example method for determining a gender for a member of a social network service, consistent with some embodiments.

FIG. 5 is a flow diagram illustrating an example method for assigning a gender to a member of a social network service, consistent with some embodiments.

FIG. 6 is a block diagram of a machine in the form of a computing device within which a set of instructions, for causing the machine to perform any one or more of the methodologies discussed herein, may be executed.

### DETAILED DESCRIPTION

### Overview

The present disclosure describes methods, systems, and computer program products, which individually provide functionality for inferring the gender of members of a social network service. For example, the systems and methods described herein determine the member is of a certain gender, and perform various action associated with the determined gender, such as gender-specific advertisements, gender-specific activities, and so on.

In some example embodiments, the systems and methods access information from a social network service that is associated with a member of the social network service, and determine a gender for the member of the social network service that is based on characteristics of the accessed information. The systems and method may then perform an action for the member that is associated with the determined gender.

For example, the systems and methods may identify a preliminary gender assignment for a member of a social network service that is based on a name and location of the member of the social network service, determine that a value of a confidence metric associated with the preliminary gender assignment is below a threshold confidence value, access information from the social network service that is associated with the member of the social network service and confirm and/or determine the preliminary gender assignment as an actual gender assignment for the member of the social network service based on gender-specific indicators of the information from the social network service.

Therefore, in some example embodiments, the systems and methods may leverage the vast knowledge contained within a social network service to infer and/or determine the gender of a member, in order to provide the member with information, experiences, activities, and other gender-specific actions within the social network service that may be of use and/or benefit to the member and other members that share the same gender, among other things.

In the following description, for purposes of explanation, numerous specific details are set forth in order to provide a thorough understanding of the various aspects of different embodiments of the present invention. It will be evident, however, to one skilled in the art, that the present invention may be practiced without all of the specific details.

Other advantages and aspects of the inventive subject matter will be readily apparent from the description of the figures that follows.

### Suitable Computing Environment

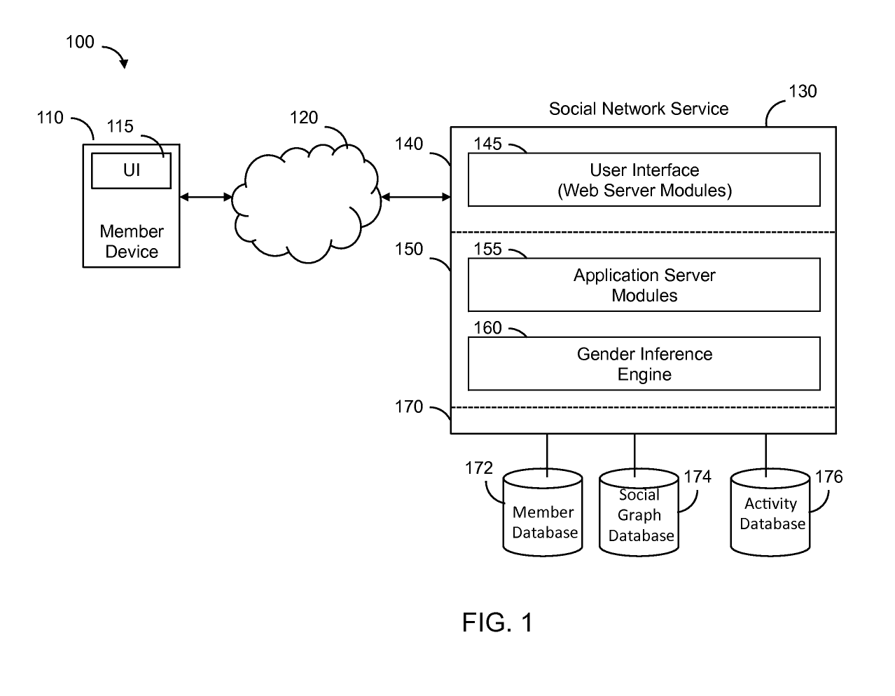

As described herein, a social network service, such as a service that provides a professional or social network of connected members, stores, contains, or is otherwise associated with information that may indicate and/or represent the gender of its members, among other things. FIG. 1 is a block diagram illustrating various functional components of a suitable computing environment 100, consistent with some embodiments, for inferring the gender of members of a social network service 130.

As shown in FIG. 1, the computing environment 100 includes a social network service 130 that is generally based on a three-tiered architecture, consisting of a front-end layer 140, an application logic layer 150, and a data layer 170. The modules, systems, and/or engines shown in FIG. 1 represent a set of executable software instructions and the corresponding hardware (e.g., memory and processor) for executing the instructions. However, one skilled in the art will readily recognize that various additional functional modules and engines may be used with the social network service 130 to facilitate additional functionality that is not specifically described herein. Furthermore, the various functional modules and engines depicted in FIG. 1 may reside on a single server computer, or may be distributed across several server computers in various arrangements.

As shown in FIG. 1, the front-end layer 140 includes a user interface module (e.g., a web server) 145, which receives requests from various client-computing devices, such as a member device 110, over a network 120, and communicates appropriate responses to the requesting client devices. For example, the user interface module(s) 140 may receive requests in the form of Hypertext Transport Protocol (HTTP) requests, or other web-based, application programming interface (API) requests. The client devices 110 may be executing conventional web browser applications, or applications that have been developed for a specific platform to include any of a wide variety of mobile devices and operating systems.

The network 120 may be any communications network utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, wireless data networks (e.g., Wi-Fi® and WiMax® networks), and so on.

As shown in FIG. 1, the data layer 170 includes several databases, including databases for storing data for various entities of the social graph, such as a member database 172 of member profile information (e.g., information identifying attributes, skills, and other information for and/or associated with members), a social graph database 174, which may include a particular type of database that uses graph structures with nodes, edges, and properties to represent and store data, such as social graph information, and an activity database 176 that stores information associated with activities (e.g., likes, endorsements, content generation such as blog or timeline posts, and so on) performed by members within the social network service 130. Of course, in some example embodiments, any number of other entities might be included in the databases, and as such, various other databases may be used to store data corresponding with other entities.

In some example embodiments, when a person initially registers to become a member of a social network supported by the social network service 130, the person will be prompted to provide some personal information, such as a name, age (e.g., birth date), gender, interests, contact information, home town, address, the names of the member's spouse and/or family members, educational background (e.g., schools, majors, etc.), current job title, job description, industry, employment history, skills, proficiencies, qualifications, professional organizations, and so on. This information is stored, for example, as member profile information or data in database 172. Often, however, some of this information, such as gender or age information, is not provided by a member, during registration or otherwise.

Once registered, a member may invite other members, or be invited by other members, to connect via the social network service 130. A “connection” may require a bi-lateral agreement by the members, such that both members acknowledge the establishment of the connection. Similarly, with some embodiments, a member may elect to “follow” another member. In contrast to establishing a “connection”, the concept of “following” another member typically is a unilateral operation, and at least with some embodiments, does not require acknowledgement or approval by the member that is being followed. When one member follows another, the member who is following may receive automatic notifications about various activities undertaken by the member being followed. In addition to following another member, a user may elect to follow a company, a topic, a conversation, a skill, or some other entity, which may or may not be included in the social graph.

The social network service 130 may provide a broad range of other applications and services that allow members the opportunity to share and receive information, often customized to the interests of the member. For example, in some example embodiments, the social network service 130 may include a photo sharing application that allows members to upload and share photos with other members. As such, a photograph may be a property or entity included within a social graph.

In some example embodiments, members of a social network service 130 may be able to self-organize into groups, or interest groups, organized around a subject matter, topic of interest, shared biography (e.g., same age group or gender), and so on. When a member joins a group, his or her membership in the group may be reflected in the social graph information stored in the social graph database 174. In some example embodiments, members may subscribe to or join groups affiliated with one or more companies. Thus, membership in a group, a subscription or following relationship with a company or group, as well as an employment relationship with a company, may all be examples of the different types of relationships that may exist between different entities, as defined by the social graph and modelled with the social graph information of the social graph database 174.

The application logic layer 150 includes various application server modules 155, which, in conjunction with the user interface module(s) 145, generates various user interfaces (e.g., web pages) with data retrieved from various data sources in the data layer 170. In some example some embodiments, individual application server modules 155 are used to implement the functionality associated with various applications, services and features of the social network service 130. For example, a messaging application, such as an email application, an instant messaging application, or some hybrid or variation of the two, may be implemented with one or more application server modules 155. Similarly, a search engine enabling users to search for and browse member profiles may be implemented with one or more application server modules 155.

In addition to the various application server modules 155, the application logic layer 150 also includes a gender inference engine 160 that infers and/or determines the gender of members of the social network service 130, such as members that do not provide information identifying their gender when registering for the social network service 130. Of course, applications or services that utilize the gender inference engine 160, such as advertising engines, recommendation engines, and so on, may be separately embodied in their own application server modules 155.

The gender inference engine 160 may perform one or more algorithmic processes that identify, determine, and/or infer the gender of one or more members of the social network service 130 based on information (e.g., information contained in databases 172, 174, and/or 176) associated with and/or provided by the social network service 130.

As illustrated in FIG. 1, in some example embodiments, the gender inference engine 160 is implemented as a service that operates in conjunction with various application server modules 155. For instance, any number of individual application server modules 155 may invoke the functionality of the gender inference engine 160, to include an application server module associated with receiving information from the member device 110 and/or an application server module associated with an application to facilitate the viewing of user interfaces presenting resource recommendations. However, in some example embodiments, the gender inference engine 160 may be implemented as its own application server module such that it operates as a stand-alone application or system.

In some example embodiments, the gender inference engine 160 may include or have an associated publicly available Application Programming Interface (API) that enables third-party applications or other applications, algorithms or scripts within the social network service 130 to invoke the functionality of the gender inference engine 160, among other things.

Thus, in some example embodiments, the gender inference engine 160, either provided by or in collaboration with the social network service 130, infers the gender of members of the social network service 130 based at least in part on information associated with the members that is contained by the social network service 130, among other things.

### Examples for Inferring Gender for Members of a Social Network Service

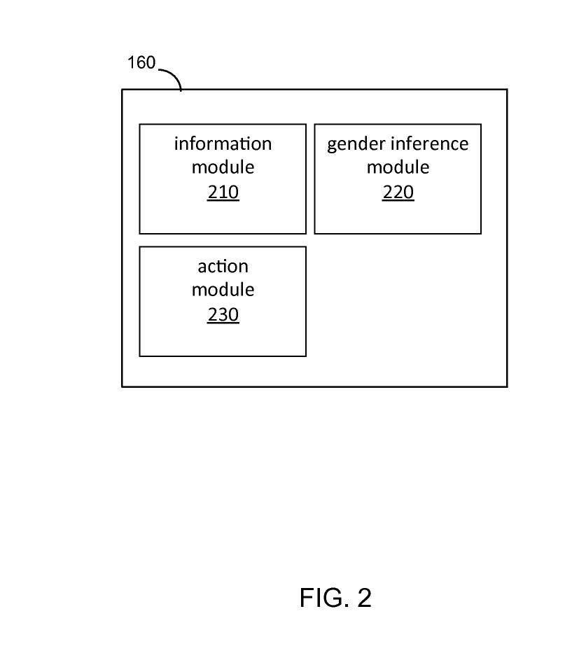

As described herein, in some example embodiments, the gender inference engine 160 includes components configured to infer, identify, and/or determine the gender of members of the social network service 130. FIG. 2 is a block diagram illustrating example modules of the gender inference engine 160, consistent with some embodiments.

As illustrated in FIG. 2, the gender inference engine 160 includes a variety of functional modules. One skilled in the art will appreciate that the functional modules are implemented with a combination of software (e.g., executable instructions, or computer code) and hardware (e.g., at least a memory and processor). Accordingly, as used herein, in some example embodiments a module is a processor-implemented module and represents a computing device having a processor that is at least temporarily configured and/or programmed by executable instructions stored in memory to perform one or more of the particular functions that are described herein. Referring to FIG. 2, the gender inference engine 160 includes an information module 210, a gender inference module 220, and an action module 230.

In some example embodiments, the information module 210 is configured and/or programmed to access and/or receive information from the social network service 130 that is associated with a member of the social network service 130. The information module 210 may access and/or receive member profile information from the member database 172, social graph information from the social graph database 174, activity information from the activity database 176, and so on.

In some example embodiments, the gender inference module 220 is configured and/or programmed to determine, identify, and/or infer a gender for the member of the social network service 130 that is based on characteristics, such as gender-specific characteristics, of the accessed information. For example, the gender inference module 220 may identify characteristics, signals, and/or indicators of a certain gender within information associated with a member, and infer the gender of the member based on the identified characteristics, signals, and/or indicators. Example characteristics, signals, and/or indicators include:

A member's first name, last name location, country of birth, citizenship, photo or image, relationship information, family information, and so on;

Pronouns (e.g., he, she, her, him, his, hers, and so on), keywords, and other gender-specific words (e.g., dad, mom, woman, man, lady, and so on) within information associated with a member, such as recommendations (e.g., “Kelly is a smart engineer and he works very hard”), blog posts (“ . . . his leadership style should be examined . . . ”), status updates (“here is our baby girl with her dad!”), and so on;

Biographical indicators, such as pictures, relationship statuses (e.g., the mom of a child or the sister of another member, and so on); and/or

Activity information, such as group affiliations (e.g., member of a women in the arts organization or a male curator group), actions performed within or via the social network service 130 (e.g., signed up for a women's conference, added content to a male sports team page, and so on), and so on.

As described herein, in some example embodiments, the gender inference module 220 may infer and/or determine a gender for a member when a metric, such as a confidence score that is associated with a likelihood that the member is the gender represented by the gender-specific characteristics, is above a threshold associated with a certainty of the inference. For example, the gender inference module 220 may positively infer a gender for a member when a confidence score (e.g., 1-10, where 10 is certain and 1 is uncertain) is above a threshold value (e.g., 8 or higher).

The gender inference module 220 may determine a confidence score in a variety of ways. For example, the gender inference module 220 may identify a baseline or preliminary gender (and associated confidence score) for a member based on the name and/or location of the member, and utilize the gender-specific characteristics from the information within the social network service 130 to update and/or modify the score. The gender inference module 220 may then infer a gender of the member as the gender assigned to the name in the database when the confidence score is above a threshold score, among other things.

In order to determine a preliminary confidence score, the gender inference module 220, in some example embodiments, may perform a comparison of information identifying a name and location of the member to a database of information that includes entries relating a name, a location, and an assigned gender to the name, as well as a confidence score determined for the assigned gender. Table 1 shows an example data structure having entries that relate a name, preliminary gender assignment, and confidence score for the preliminary assignment at a certain geographical location (e.g., USA):

TABLE 1

| Name | Preliminary Gender | Confidence Score |
|---|---|---|
| Kelly | Female | 8.55 |
| Michael | Male | 9.95 |
| Jordan | Male | 7.25 |
| Pat | Female | 6.05 |
| Jamal | Male | 10.00 |

As shown in Table 1, a member having the name Jamal in the United States is certain to be male, whereas a member having the name of Pat may be either male or female. Thus, for names below a certain confidence score (e.g., the names Kelly, Jordan, and Pat are assigned confidence scores below 9), the gender inference module 220 utilizes information from the social network service 130 in order to infer the gender of the members with a greater certainty.

For example, for a certain member named Kelly, born and located in the USA and assigned a preliminary gender of female, the gender inference module 220 may identify various gender-specific characteristics based on information associated with the member from the social network service 130 (e.g., the member is affiliated with a women's ski team and has three recommendations that refer to the member as a “she”)), and increase the confidence score for the gender assignment of “female” that is attributed to the member.

Therefore, given an input of a name (e.g., first, middle, last) and/or location (e.g., place of birth, citizenship, current location, and so on), the gender inference module 220 may identify a preliminary gender assignment for the member, determine that a value of a confidence metric associated with the preliminary gender assignment is below a threshold confidence value (e.g., via Table 1), access information from the social network service 130 that is associated with the member of the social network service (e.g., gender-specific characteristics or indicators), and confirm the preliminary gender assignment as an actual gender assignment for the member of the social network service based on gender-specific indicators of the information from the social network service 130, among other things.

In some example embodiments, the action module 230 is configured and/or programmed to perform an action for the member that is associated with the determined gender. For example, the action module 230 may present an advertisement to the member that is targeted to members of the determined gender, may perform a task within the social network service 130 for the member that is targeted to members of the determined gender, may provide a recommendation for the member that is associated with the determined gender, and so on.

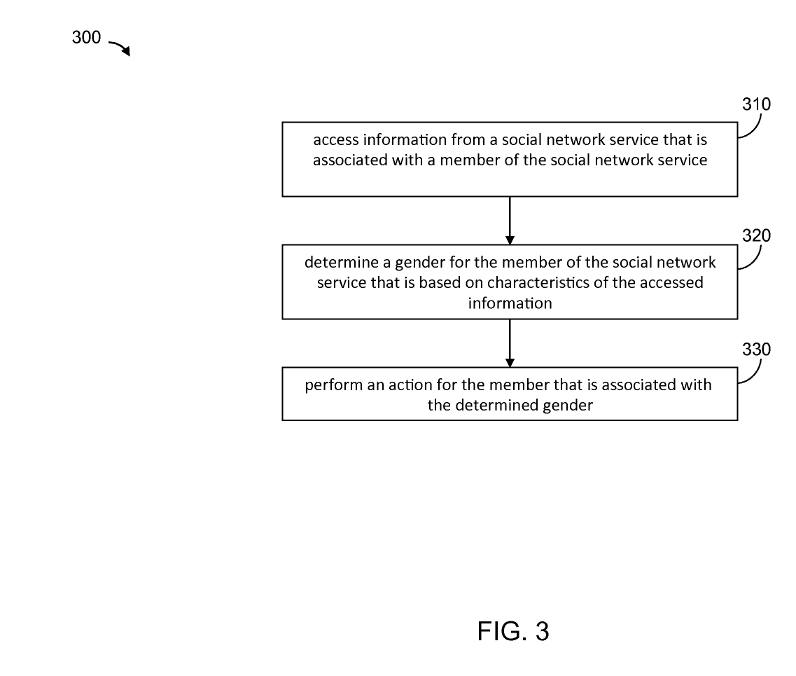

As described herein, the gender inference engine 160 may perform various methods in order to infer or otherwise determine the gender for a member or members of the social network service 130. FIG. 3 is a flow diagram illustrating an example method 300 for performing an action for a member of a social network service that is based on an inferred gender for the member, consistent with some embodiments. The method 300 may be performed by the gender inference engine 160 and, accordingly, is described herein merely by way of reference thereto. It will be appreciated that the method 300 may be performed on any suitable hardware.

In operation 310, the gender inference engine 160 accesses information from the 130 social network service that is associated with a member of the social network service 130. For example, the information module 210 may access and/or receive member profile information from the member database 172, social graph information from the social graph database 174, activity information from the activity database 176, and so on.

In operation 320, the gender inference engine 160 may determine a gender for the member of the social network service 130 that is based on characteristics of the accessed information. For example, the gender inference module 220 may identify characteristics, signals, and/or indicators of a certain gender within information associated with a member, and infer the gender of the member based on the identified characteristics, signals, and/or indicators.

As described herein, in some example embodiments, the gender inference module 220 may determine a gender for the member when a confidence score associated with the gender determination is above a threshold score indicative of a relative certainty that the determined gender is statistically accurate with respect to member.

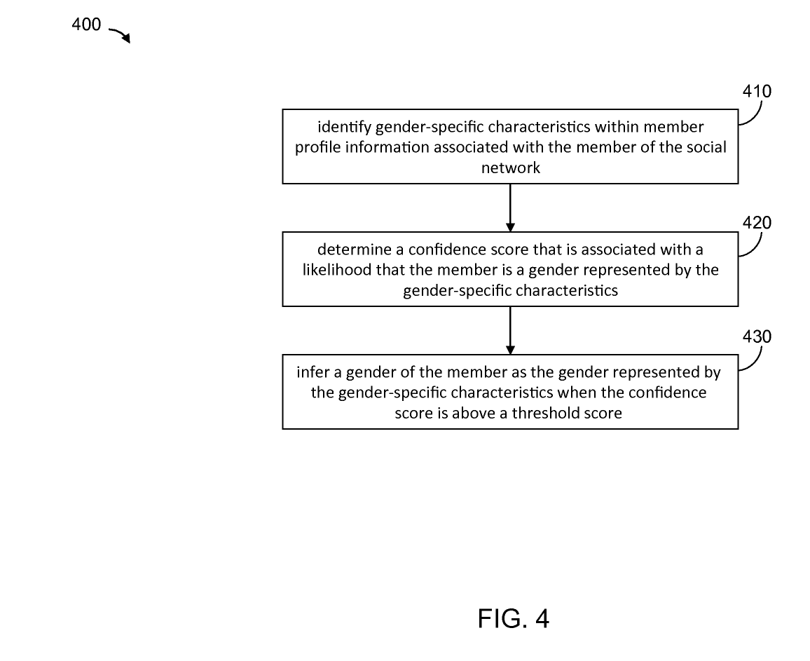

FIG. 4 is a flow diagram illustrating an example method 400 for determining a gender for a member of the social network service 130, consistent with some embodiments. The method 400 may be performed by the gender inference engine 160 and, accordingly, is described herein merely by way of reference thereto. It will be appreciated that the method 400 may be performed on any suitable hardware.

In operation 410, the gender inference engine 160 identifies gender-specific characteristics within member profile information associated with the member of the social network. For example, the gender inference module 220 identifies pronouns indicative of a certain gender within recommendations associated with the member.

In operation 420, the gender inference engine 160 determines a confidence score that is associated with a likelihood that the member is a gender represented by the gender-specific characteristics. For example, the gender inference module 220 calculates a score for the gender assigned to the member based on the identified pronouns.

In operation 430, the gender inference engine 160 infers a gender of the member as the gender represented by the gender-specific characteristics when the confidence score is above a threshold score. For example, the gender inference module 220 compares the calculated score to a threshold score, as described herein, and assigns the gender to the member when the score satisfies the threshold score. The gender inference module 220 may assign the member with an “unknown” or “either” gender when the score does not satisfy the threshold score.

In some example embodiments, the gender inference engine 160 may vary the threshold score, based on the application and/or utilization of the assigned gender by the action module 230, among other things. For example, the gender inference engine 160 may apply a lower threshold score (e.g., 9 out of 10) when determining the gender for advertising purposes (as an incorrectly targeted advertisement may not bother the member), whereas the gender inference engine 160 may apply a higher threshold score (e.g., 9.9 out of 10) when providing recommendations to the member (as an incorrect gender group recommendation may in fact bother the member), among other things.

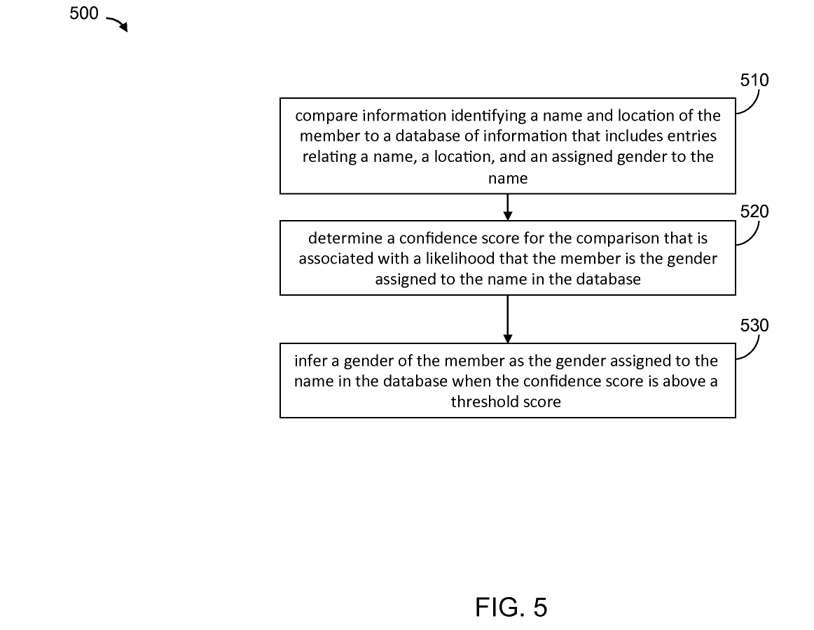

As described herein, in some example embodiments, the gender inference module 220 may determine a preliminary gender assignment for the member, and determine an actual gender for the member based on the preliminary assignment. FIG. 5 is a flow diagram illustrating an example method 500 for assigning a gender to a member of a social network service, consistent with some embodiments. The method 500 may be performed by the gender inference engine 160 and, accordingly, is described herein merely by way of reference thereto. It will be appreciated that the method 500 may be performed on any suitable hardware.

In operation 510, the gender inference engine 160 compares information identifying a name and location of the member to a database of information that includes entries relating a name, a location, and an assigned gender to the name. For example, the gender inference module 220 may compare member information to information contained in a database relating names to gender assignments, such as Table 1.

In operation 520, the gender inference engine 160 determines a confidence score for the comparison that is associated with a likelihood that the member is the gender assigned to the name in the database. For example, the gender inference module 220 may modify and/or adjust the confidence score associated with the gender assignment based on gender-specific signals within member information from the social network service 130.

In operation 530, the gender inference engine 160 infers a gender of the member as the gender assigned to the name in the database when the confidence score is above a threshold score. For example, the gender inference module 220 compares the modified confidence score to a threshold score, and infers the gender based on the comparison.

Thus, given an input of a name (e.g., first, middle, last) and/or location (e.g., place of birth, citizenship, current location, and so on), the gender inference module 220, in some example embodiments, identifies a preliminary gender assignment for the member, determines that a value of a confidence metric associated with the preliminary gender assignment is below a threshold confidence value (e.g., via Table 1), accesses information from the social network service 130 that is associated with the member of the social network service (e.g., gender-specific characteristics or indicators), and confirms the preliminary gender assignment as an actual gender assignment for the member of the social network service based on gender-specific indicators of the information from the social network service 130, among other things.

Referring back to FIG. 3, the gender inference engine 160 performs an action for the member that is associated with the determined gender. For example, the action module 230 may present a gender-specific advertisement to the member that is targeted to members of the determined gender, may perform a gender-specific task within the social network service 130 for the member that is targeted to members of the determined gender, may present a recommendation within the social network service 130 for the member that is targeted to members of the determined gender, and so on.

Thus, in some example embodiments, the systems and methods described herein may utilize an inferred and/or determined gender for one or more members of the social network service 130, and tailor the member's experience (e.g., sponsored content viewing, recommendations, interests, and so on) based on the inferred and/or determined gender.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules, engines, objects or devices that operate to perform one or more operations or functions. The modules, engines, objects and devices referred to herein may, in some example embodiments, comprise processor-implemented modules, engines, objects and/or devices.

Similarly, the methods described herein may be at least partially processor-implemented. For example, at least some of the operations of a method may be performed by one or more processors or processor-implemented modules. The performance of certain operations may be distributed among the one or more processors, not only residing within a single machine or computer, but deployed across a number of machines or computers. In some example embodiments, the processor or processors may be located in a single location (e.g., within a home environment, an office environment or at a server farm), while in other embodiments the processors may be distributed across a number of locations.

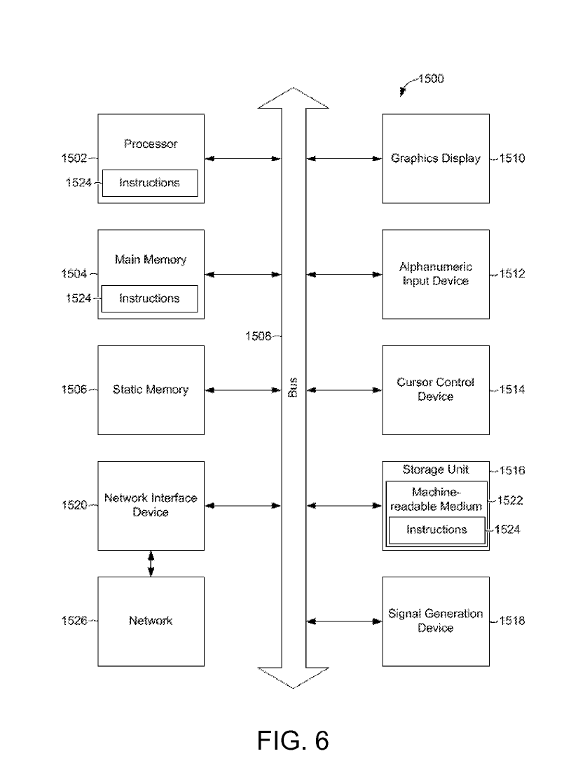

FIG. 6 is a block diagram of a machine in the form of a computer system or computing device within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment. In some embodiments, the machine will be a desktop computer, or server computer, however, in alternative embodiments, the machine may be a tablet computer, a mobile phone, a personal digital assistant, a personal audio or video player, a global positioning device, a set-top box, a web appliance, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1502 (e.g., a central processing unit (CPU), a graphics processing unit (GPU) or both), a main memory 1504 and a static memory 1506, which communicate with each other via a bus 1508. The computer system 1500 may further include a display unit 1510, an alphanumeric input device 1512 (e.g., a keyboard), and a user interface (UI) navigation device 1514 (e.g., a mouse). In one embodiment, the display, input device and cursor control device are a touch screen display. The computer system 1500 may additionally include a storage device 1516 (e.g., drive unit), a signal generation device 1518 (e.g., a speaker), a network interface device 1520, and one or more sensors, such as a global positioning system sensor, compass, accelerometer, or other sensor.

The drive unit 1516 includes a machine-readable medium 1522 on which is stored one or more sets of instructions and data structures (e.g., software 1524) embodying or utilized by any one or more of the methodologies or functions described herein. The software 1524 may also reside, completely or at least partially, within the main memory 1504 and/or within the processor 1502 during execution thereof by the computer system 1500, the main memory 1504 and the processor 1502 also constituting machine-readable media.

While the machine-readable medium 1522 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 1524 may further be transmitted or received over a communications network 1526 using a transmission medium via the network interface device 1520 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although some embodiments has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

1. A method, comprising:
accessing, with a processor, information from a social network service that is associated with a member of the social network service, the information including at least a name and a location of the member, the member having a gender;
determining, with the processor, a gender for the member of the social network service based, at least in part, on a database including a preliminary gender and a confidence score, both the preliminary gender and the confidence score being associated with the name and the location, the confidence score being indicative of a confidence that the preliminary gender is the gender of the member; and
providing, via a user interface, an output based on the gender as determined.

2. The method of claim 1, further comprising;
performing an action for the member that is associated with the determined gender.

3. The method of claim 1, further comprising:
presenting an advertisement to the member that is targeted to members of the determined gender.

4. The method of claim 1, further comprising:
performing a task within the social network service for the member that is targeted to members of the determined gender.

5. The method of claim 1, further comprising:
presenting a recommendation within the social network service for the member that is targeted to members of the determined gender.

6. The method of claim 1, wherein determining a gender for the member of the social network service includes:
inferring a gender for the member based on gender-specific characteristics within member profile data associated with the member of the social network.

7. The method of claim 1, wherein accessing information further includes gender-specific characteristics of the member and wherein determining the gender for the member of the social network service includes:
determining the preliminary gender and the confidence score based on the name and the location, the confidence score being a location confidence score;
determining a gender-specific characteristic confidence score that is associated with a likelihood that the gender of the member represented by the gender-specific characteristics; and
determining the gender of the member based, at least in part, on the a combination of the location confidence score and the gender-specific characteristic confidence score relative being above a threshold score.

8. (canceled)

9. The method of claim 1, wherein determining the gender for the member of the social network service includes:
determining the gender of the member as the preliminary gender when the confidence score is above a threshold score.

10. A computer-implemented system, comprising:
a hardware-implemented information module that is configured to access information from a social network service that is associated with a member of the social network service, the information including at least a name of the member and a location of the member; and
a hardware-implemented gender inference module that is configured to determine a gender of the member based, at least in part, on a database including a preliminary gender and a confidence score, both the preliminary gender and the confidence score being associated with the name and the location, the confidence score being indicative of a likelihood that the preliminary gender is the gender of the member; and
a hardware-implemented action module that is configured to perform an action for the member that is associated with the determined gender.

11. The system of claim 10, wherein the action module is configured to present an advertisement to the member that is targeted to members of the determined gender.

12. The system of claim 10, wherein the action module is configured to perform a task within the social network service for the member that is targeted to members of the determined gender.

13. The system of claim 10, wherein the gender inference module is configured to infer a gender for the member based on gender-specific characteristics within member profile data associated with the member of the social network.

14. The system of claim 10, wherein the gender inference module is configured to:
identify gender-specific characteristics within member profile information associated with the member of the social network, the information including at least a name of the member and a location of the member;
determine a confidence score that is associated with a likelihood that the member is a gender represented by the gender-specific characteristics; and
infer a gender of the member as the gender represented by the gender-specific characteristics when the confidence score is above a threshold score

15. The system of claim 10, wherein the gender inference module is configured to infer a gender for the member based on a comparison of information identifying a name and location of the member to a database of information that includes entries relating a name, a location, and an assigned gender to the name.

16. (canceled)

17. A non-transitory computer-readable storage medium whose contents, when executed by a computing system, cause the computing system to perform operations, comprising:
identifying, from a database, a preliminary gender assignment and a confidence score for a member of a social network service that is based on a name and location of the member of the social network service, the confidence score being indicative of a confidence that the preliminary gender assignment corresponds to a gender of the member;
determining that the confidence score is below a threshold confidence value;
accessing information from the social network service that is associated with the member of the social network service; and
confirming the preliminary gender assignment as the gender for the member of the social network service based on gender-specific indicators of the information from the social network service.

18. The computer-readable storage medium of claim 17, wherein the gender-specific indicators include keywords associated with a specific gender that are contained within member profile data for the member of the social network service.

19. The computer-readable storage medium of claim 17, wherein the gender-specific indicators include keywords associated with a specific gender that are contained within content published within the social network service that is associated with the member.

20. The computer-readable storage medium of claim 17, wherein the gender-specific indicators include one or more activities performed by the member within the social network service.
